(19) United States
(12) Patent Application Publication
(10) Pub. No.: US 2005/0166158 A1
(43) Pub. Date: Jul. 28, 2005

(54) Semi-transparency in size-constrained user interface

(75) Inventors: John A. Blanchard III, Algonquin, IL (US); Jennifer Martin, Chicago, IL (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/755,833

(22) Filed: Jan. 12, 2004

(51) Int. Cl. G06F 3/00; G09G 5/00

(52) U.S. Cl. 715/768; 715/792; 715/797; 715/856; 715/810; 345/629

(57) ABSTRACT

The present invention provides a method that increases screen space of a computing device by using semi-transparent functional areas that overlap non-functional content areas on the screen. This method allows for relatively large functional targets on the screen—thus mitigating the usability problems associated with tiny buttons and other images—while also allowing the underlying content on the screen to be clearly visible. A main design feature of this invention is that two functional areas are never allowed to overlap. An overlap condition would cause user confusion as to which layer is active. Instead, the interface is designed to foreground functionality in all instances.

### FIELD OF THE INVENTION

The present invention relates to a method for displaying information on a screen and in particular the present invention relates to a method for presenting user interface controls of varying degrees of transparency on a screen and over non-functional areas of the screen.

### BACKGROUND OF THE INVENTION

Portable computer systems are becoming more powerful, smaller and lighter with each few months. Notebook computers have been available for some time. These computers are generally about 8½ inches in width, 11 inches in length and 1½ to 2 inches thick. They include a liquid crystal display (LCD) screen, a keyboard, a floppy disk and or hard disk and various other ports and items standard on desktop computers. Typically they weigh from 5 to 9 pounds, including batteries. Data input and application interaction is generally accomplished by using the keyboard. One problem has been the need to learn to type to efficiently operate the system and the need of a stable location for the computer when you must type. However, keyboard input is often very precise, so that complicated commands can be entered without numerous errors.

One newer arrival in the class of portable computer systems is the slate or notepad computer. In this type of computer a stylus is used to write directly on the LCD screen used in the unit. A digitizer captures the movements of the stylus and software in the computer converts the movement to commands, either by monitoring location when the system is being used in a touch screen-like mode, or by converting the movements into specific characters, which then form the command or data. Thus there is no reason to learn to type. By using the computer as a notepad, no resting space is required for operation of the unit. However, very specialized software is required, the processing may be slow, characters may be misinterpreted and various other problems may occur. One advantage of a notepad is that the unit may be very small.

Another portable device is the personal digital assistant (‘PDA’) . This device, which is usually 3 inches by 5 inches in area, comprises a screen and a set of control buttons. The PDA has become a very popular deice for persons that need a certain amount of computing power, but also have limited space in which to carry and the use computing device. In addition, technological enhancements have made the cellular telephone a device that can also accommodate certain computing demands of the user.

The proliferation of portable computing devices and the compact visual interfaces that often introduce limitations on the amount of screen area available for functional images/icons and for screen content. The desire to offer the user the smallest possible device while simultaneously maximizing on-screen content is fundamentally at odds with long-known usability precepts defining the minimum usable size for functional images. Indeed, screens that allow users to interact using touch have the added problem of requiring very large interactive targets to handle the relative imprecision of the human finger as an input mode. In addition, larger targets are more desirable on mobile devices that are often jostled about or not held perfectly still for interaction.

Many solutions to this problem have been proposed, all of which have drawbacks. Device manufactures have created standard re-usable “hard” buttons physically separate from the screen area that applications can access. These buttons remove the need to devote screen space to buttons but also force the user to map the function of the button mentally since normally the buttons have default system uses that are different from their application uses. Another solution involves reducing the size of functional areas and/or the size of content, but usability and legibility quickly deteriorate using this method. Lastly, context-sensitive tap-and-hold menus have been implemented to “hide” functionality until the user requests it. This method is useful but prevents a ready disclosure of available actions: the user must test to see if an item can be acted upon before doing so. Many of these pitfalls are detailed in Harpold, Terry, et al, “Using small screen space more efficiently”, CHI'96 Proceedings, 1996.

Conventional computing systems utilize specially developed screen displays that incorporate individual display images, as well as display information, that are presented in formats that allow the user to effectively gain access to information contained in the information management system. Therefore, a particular screen display can be viewed as having both display “tools” (also called graphical user interface tools) and display “information.” In this configuration, the screen has defined display regions. Typically, the display tools reside within a tool region and the display information resides within an information region. The display tools are used to give the user special abilities to organize, manage and access information while the display “information” constitutes either the resultant data desired or the application program the user desires to interact with or otherwise operate.

However within many computing devices the display screens are quite small. Especially those display screens that are associated with portable computer systems, portable electronic devices that act as information management systems and portable and/or handheld consumer-based electronic devices. For instance, personal digital assistants (PDAs) can be quite small, e.g., palm sized, and have correspondingly small display screens. Many consumer-based electronic devices, e.g., camcorders and telephones, also have reduced-sized display screens that are used for interacting with the device. In these cases, the display screen doubles as an information input device by using touch screen technology. In these cases, it is important to maximize the usable area of the display screen for viewing information because of the small physical dimensions of some, the screen is small and in many devices, the display screen also serves as an information input mechanism (e.g., in the case of a touch screen).

Several patents have attempted to address various aspects related to incorporating control icons in a limited amount of screen space. U.S. Pat. No. 5,388,202 describes a method for generating window borders having pictorial frame elements. However, U.S. Pat. No. 5,388,202 describes generating a window frame, or border, that is always displayed around and separate from the information content. The window frame, or border, is not transparent and therefore does not allow the display of information there through. This patent does not describe a mechanism for increasing the viewable area of a display screen because it requires the use of display screen area for a graphical image of the window frame that is separate from the displayed user information.

U.S. Pat. No. 5,651,107 describes the use of a transparency or alpha blending by allowing data of other windows to be viewed through windows that lie on top of the window that contains data.

U.S. Pat. No. 6,057,840, discusses the use of the scroll bar to increase the viewable area user information on a display screen.

Computer systems are used today in wide applications that involve accessing and displaying information generally in response to some user interaction (e.g., via a keyboard and/or a cursor directing device). Information management systems, such as those, which are used or can be adapted for use in computer systems, are placing increasing demands on the physical resources available for displaying information on a display screen. In many applications, it is always desired to display more information on a display screen so that a user can maximize the amount of information presented to him or her. Therefore, there exists a need for better and more efficient mechanisms and methods for presenting information to a user via a computer display screen.

### SUMMARY OF THE INVENTION

It is an objective of the present invention to provide a control menu for a hand-held computing device that does not require dedicated screen space.

It is a second objective of the present invention the provide method and system for displaying control images on a screen in a transparent manner.

It is a third objective of the present invention to provide a method of determining the arrangement of the control images on a screen such that none of the control images overlap.

It is a fourth objective of the present invention to provide a method for displaying control images on a screen in varying degrees of transparency.

It is a fifth objective of the present invention to provide a method to position control images on a screen in a manner that will minimize the motion required by the user to activate a control image.

It is a sixth objective of the present invention to provide a layered screen that contains functional areas and non-functional content areas.

It is a seventh objective of the present invention to provide a method that will expand the functional area of a screen through the display of semi-transparent control images over non-functional screen space.

The present invention provides a method that increases screen space of a computing device by using semi-transparent functional areas that overlap non-functional content areas on the screen. This method allows for relatively large functional targets on the screen—thus mitigating the usability problems associated with tiny buttons and other images—while also allowing the underlying content on the screen to be clearly visible. This approach is superior to hard button solutions because the user's attention can stay focused on the screen and it allows for disabling the hard buttons in kiosk-mode device configurations. Semi-transparency is also superior to context-sensitive pop-ups because it makes functionality readily apparent to the user, eliminating extra effort to “uncover” areas of interactivity. Lastly, semi-transparency allows for relatively large functional targets, significantly reducing mistaken interaction on the screen.

In the method of the present invention, the first step is to determine the dimensions of a control image that will appear on the screen. These control images are related to an application that will be executed by the computing device. This control image determination will be based on an estimate of the amount of area that a user needs in order to easily activate a control icon using a touch screen. The next step is to determine the screen dimensions of the device. This dimension-determining step will enable the process to know the amount of space available for overlaying of images. Based on the screen dimensions and the control icon dimensions, there is an internal calculation of the maximum number of icons that can be ideally placed on the screen such that proper icon spacing is maintained. The final step is to display up to a maximum number of control images on the screen in a transparent manner. The transparent images would be analogous to a watermark on a surface. The user will be able to detect the images, but the appearance of the images will not detract from the content on the screen.

The present invention uses technology interfaces that can accommodate layered images and varying degrees of transparency. Interactive targets/images automatically reveal the content beneath them. A key design feature of this invention is that two functional areas are never allowed to overlap. An overlap condition would cause user confusion as to which layer were active. Instead, the interface is designed to foreground functionality in all instances.

### DESCRIPTION OF THE DRAWINGS

FIG. 1 is an illustration of a conventional notepad-computing device.

FIG. 2 is an illustration of a conventional personal digital assistant (PDA) device.

FIG. 3 is an illustration of a conventional display screen for a notepad-computing device containing multiple icons that represent functions of the application executing on the computer.

FIG. 4 is an illustration of a conventional display screen for a notepad-computing device in which the icons that represent functions of the application executing on the computer are displayed on the computer screen in a transparent manner.

FIG. 5 is an actual illustration of the implementation of the present invention on a personal digital assistant device (PDA).

FIG. 6 is a flow diagram of the general steps in the implementation of the present invention.

FIG. 7 is a flow diagram of the steps in a specific implementation of the present invention.

### DETAILED DESCRIPTION OF THE INVENTION

The present invention describes method for displaying control menus on a screen in a transparent manner. This method enable the user of a computing device to activate functions corresponding to the menu items, by touching the menu icon that is displayed in a transparent manner on the screen. The ability to display these items on the screen will allow for a larger screen area on the device and will reduce the need for dedicated space on the device for control buttons.

The primary application for the method of the present invention is hand-held computing devices. These devices are smaller in size than a conventional computer or a portable laptop computer. In addition, devices that employ touch-screen control procedures are a primary application of the invention.

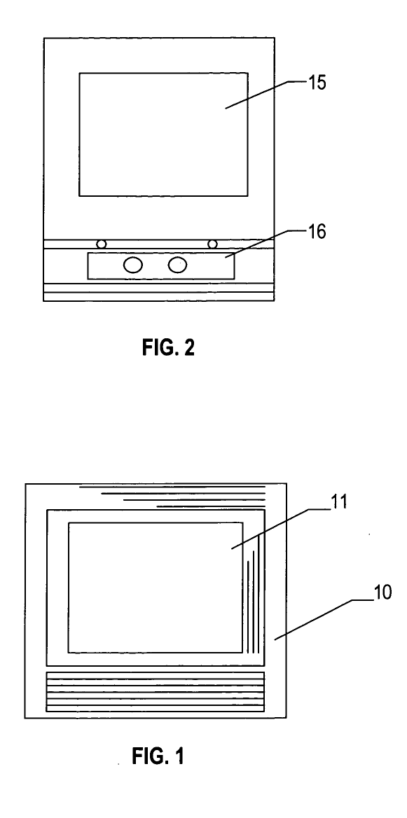

FIG. 1 illustrates a conventional computing-notepad device. These devices comprise a housing 10 and a screen 11. The processing and storing functions are internal and not shown in this figure. Commands for the device are input through a touch-screen activation process. FIG. 2 shows a personal digital assistant (PDA) interface which a can enable communication between a user and the reservation center via a computer network. This PDA has internal processing and store capabilities. As shown, it also has a screen 15 and input controls 16.

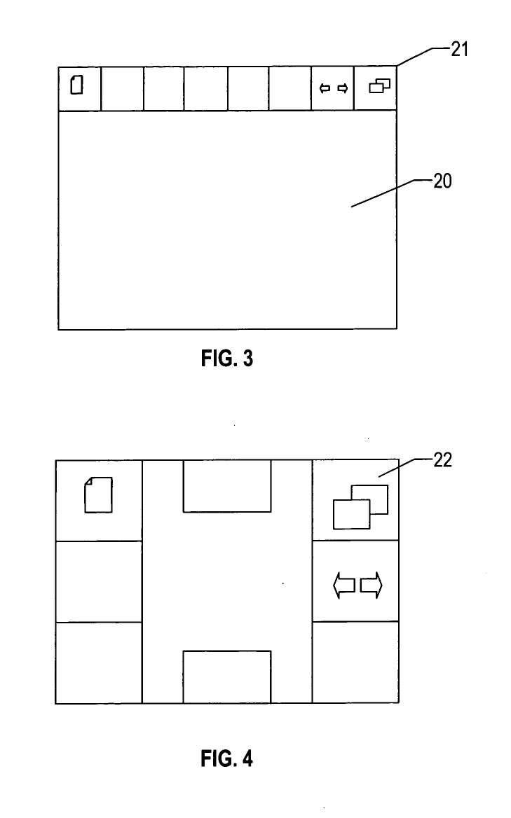

FIG. 3 is an illustration of a conventional display screen for a notepad-computing device containing multiple icons that represent functions of the application executing on the computer. As shown, the screen has two sections. The content section 20 is where the content of the message of activity is displayed to the user. The control section 21 contains a control menu with icons that correspond to various control functions. This two-section screen configuration is a typical screen configuration found on the large majority of computing devices. FIG. 3 also illustrates the primary problem with this configuration. The control section 21 occupies approximately one quarter of the screen space. For small computing devices, this use of the limited screen space restricts the amount of content information that can be display to the viewer. Furthermore, with the smaller hand-held touch activated devices; the smaller control icons make it more difficult for the user to select the proper icon with inadvertently touching the adjacent, but undesirable control icon.

FIG. 4 is an illustration of a conventional display screen for a notepad-computing device in which the icons that represent functions of the application executing on the computer are displayed on the computer screen in a transparent manner and in accordance with the present invention. As shown, the control icons 22 have larger dimensions than that the same icons shown in FIG. 3. In addition, these icons are also displayed in a transparent manner such that content information can be shown under these icons. The user is able to view the content information with little to no distraction from the overlay of the control icons over the content information. This configuration of the screen enlarges the amount of the screen that is used for content information while providing the user with control icons that reduce the risk of mistakes from inadvertent touching of other control icons.

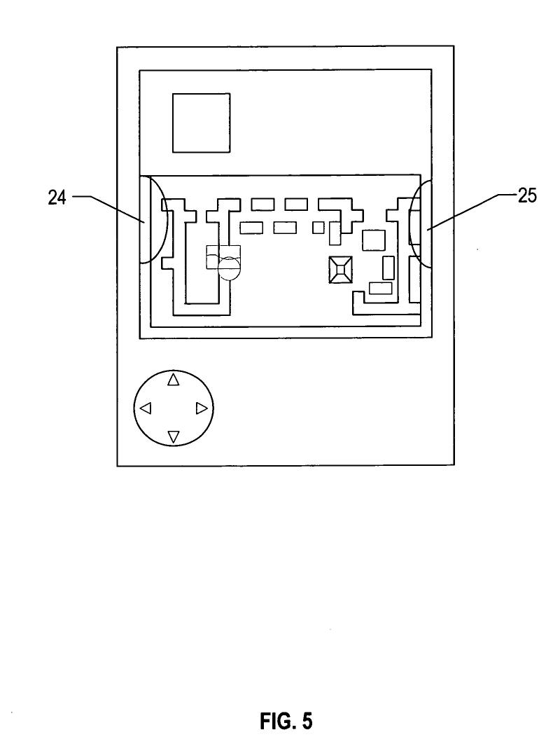

FIG. 5 is an actual illustration of the implementation of the present invention on a personal digital assistant device (PDA). As shown, this device contains content information in the form of a map/floor plan. In this particular FIG. 5, the view is a layout of a floor plan for a museum. The device will enable the user to navigate through the museum. The device also has two control icons 24 and 25. Control icon 24 represents a previous function that will enable the user to go to a previous view of the floor plan. The next icon 25 will enable to user to navigate to the next point in the floor plan. As seen in the Figure, the control icons 24 and 25 are transparently imposed over the content view without obstruction of the content on the screen.

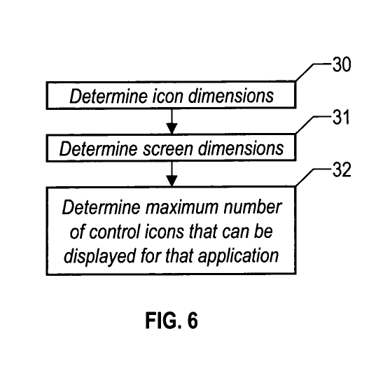

FIG. 6 is a flow diagram of the general steps in the implementation of the present invention. The implementation of the present invention can through transparency technology such as “Macromedia Flash”. In the method of the present, there are some initial steps that will be performed for each computing device. As shown, the first of these steps, 30, determines the dimensions of control icons that will be positioned on the screen in a transparent manner. The dimensions for a control icon will be based on the area needed for a user to easily access/touch the icon on the screen without inadvertently touching and activating adjacent control icons. The next step, 31, is to determine the dimensions of the screen of the computing device. The determination of these two sets of dimensions will enable the method of the present invention to determine, in step 32, the maximum number of control icons that can be reasonably displayed on the screen. This maximum number will be for any application executing on this particular computing device. These steps 30, 31 and 32 are one-time steps that can be implemented when the method of the present is installed on a computing device. Once this information is determined, it will be the same for control icons for any application.

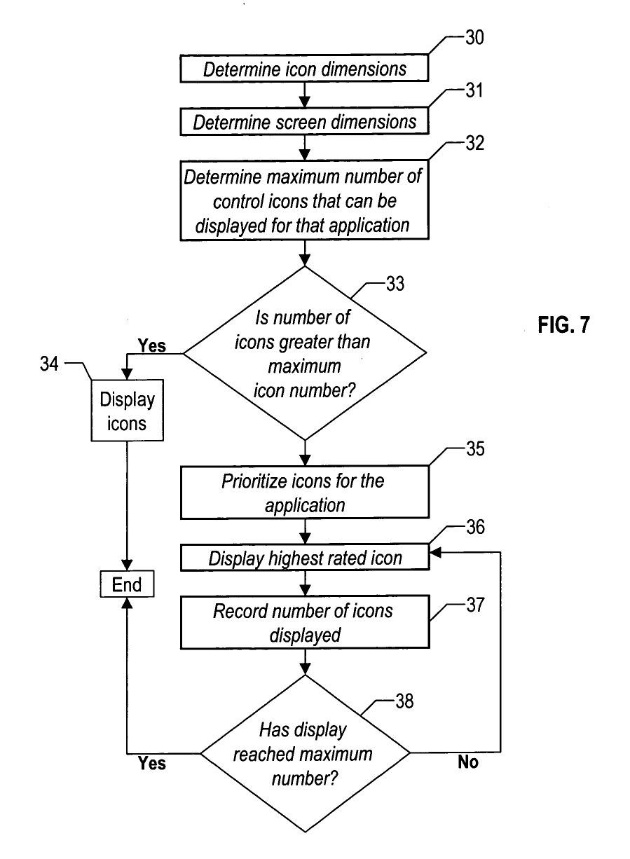

FIG. 7 is a flow diagram of the steps in a specific implementation of the present invention. This aspect of the method occurs when the user accesses a particular application. The applications could any application that incorporates control icons. Some of these programs could be editor application programs analogous to Microsoft Word, PowerPoint or Excel. In this process, step 33 determines whether the number of control icons for the application is greater than the maximum number of icons that can be displayed as determined in step 32. If the number of icons determined in step 33 is less than the maximum number for display on this device, the method moves to step 34 where all of icons can be displayed in a transparent manner on the screen. If the determination in step 33 is that there are more control icons than the maximum number allowed for this device, the method moves to step 35 where the control icons are prioritized for inclusion on the screen. One basis for prioritization can be the frequency of use of the control icons. The icons used more frequently would have a higher priority than those not use as often.

At the completion of the prioritization step 35, step 36 will begin the process of including the control icons on the screen display. After an icon is displayed, step 37 will designate the next icon available for insertion into the display. This step 37 can also include a counting activity to maintain an accurate count of the number of icons that have been inserted into the display. Step 38 will review the count of icons that have been inserted into the display and determine whether the maximum number of icons for this display has been equaled in the present application. If the maximum number has been equally, the method terminates. If the number of inserted icons has not equaled the maximum number, the method returns to step 36 for display of the next control icon.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claims as new and desire to secure by Letters Patent is set forth in the following claims.

1. A method for increasing screen space of a computing device using semi-transparent functional control areas on the screen comprising the steps of:
determining the size of control images for display on the screen;
determining the overall display area of the screen of the computing device; and
displaying control images on the screen of the computing device in a semitransparent state such that screen content remains visible and such that no images share any of the same space on the screen.

2. The method as described in claim 1 further comprising before said displaying step, the step of determining the maximum number of control images that can be displayed in the overall area of the screen such that no images have any overlap on the screen.

3. The method as described in claim 2 further comprising after said maximum control image determining step, the steps of:
in response to a user request, retrieving an application program;
determining the number of control images for display from retrieved program; and
when the number is control is less that the maximum number of images that can be displayed on that screen, displaying the control images for that program.

4. The method as described in claim 2 further comprising after said maximum control image determining step, the steps of:
in response to a user request, retrieving an application program;
determining the number of control images for display from retrieved program;
when the determination is that the number of control images for display is greater than the maximum number of control images for that screen, ranking the control images for that program; and
displaying the control images in an order according to the rank of the control images.

5. The method as described in claim 4 wherein said displaying step further comprises the steps of:
displaying a control image on the screen;
incrementing a control image display number count;
comparing the display count with the maximum number of control images for that screen; and
displaying the next control image on the screen when the display count is less than the maximum number of control images for that screen.

6. The method as described in claim 4 wherein said displaying step further comprises the steps of:
displaying a control image on the screen;
incrementing a control image display number count;
comparing the display count with the maximum number of control images for that screen; and
terminating the method when the display count is equal to the maximum number of control images for that screen.

7. The method as described in claim 4 wherein the ranking process by prioritizing the control images according to the frequency of use of the control image.

8. A computer program product in a computer readable medium for increasing screen space of a computing device using semi-transparent functional control areas on the screen comprising:
instructions for determining the size of control images for display on the screen;
instructions for determining the overall display area of the screen of the computing device; and
instructions for displaying control images on the screen of the computing device in a semitransparent state such that screen content remains visible and such that no images share any of the same space on the screen.

9. The computer program product as described in claim 8 further comprising before said displaying instructions, instructions for determining the maximum number of control images that can be displayed in the overall area of the screen such that no images have any overlap on the screen.

10. The computer program product as described in claim 9 further comprising after said maximum control image instructions:
in response to a user request, instructions for retrieving an application program;
instructions for determining the number of control images for display from retrieved program; and
when the number is control is less that the maximum number of images that can be displayed on that screen, instructions for displaying the control images for that program.

11. The computer program product as described in claim 9 further comprising after said maximum control image determining instructions:
in response to a user request, instructions for retrieving an application program;
instructions for determining the number of control images for display from retrieved program;
when the determination is that the number of control images for display is greater than the maximum number of control images for that screen, instructions for ranking the control images for that program; and
instructions for displaying the control images in an order according to the determined rank of the control images.

12. The computer program product as described in claim 11 wherein said displaying instructions for further comprise:
instructions for displaying a control image on the screen;
instructions for incrementing a control image display number count;
instructions for comparing the display count with the maximum number of control images for that screen; and
instructions for displaying the next control image on the screen when the display count is less than the maximum number of control images for that screen.

13. The computer program product as described in claim 11 wherein said displaying instructions further comprise:
instructions for displaying a control image on the screen;
instructions for incrementing a control image display number count;
instructions for comparing the display count with the maximum number of control images for that screen; and
instructions for terminating the method when the display count is equal to the maximum number of control images for that screen.

14. A computing device using semi-transparent functional control areas on the screen comprising:
a processing unit incorporated within the computing device;
a screen for displaying information to the user of the computing device, said screen comprising a content layer and a control layer, said control layer further comprising non-overlapping semi-transparent functional control areas on the screen; and
control software for implementation of control functions corresponding to the semi-transparent control areas.

15. The computing device as described in claim 14 wherein said control layer overlays said content layer on said screen.

16. The computing device as described in claim 14 wherein the control areas and said control software comprise a user interface for the computing device.

17. The computing device as described in claim 16 wherein said screen is a touch control screen.

18. The computing device as described in claim 14 further comprising control buttons not positioned on the device screen.
